(19) United States
(12) Patent Application Publication
(10) Pub. No.: US 2017/0366583 A1
(43) Pub. Date: Dec. 21, 2017

(54) SYSTEMS AND METHODS FOR REMOTE FORENSICS AND DATA SECURITY SERVICES OVER PUBLIC AND PRIVATE NETWORKS

(71) Applicants: Matthew Martin Shannon, Tampa, FL (US); Matthew James Decker, Valrico, FL (US)

(72) Inventors: Matthew Martin Shannon, Tampa, FL (US); Matthew James Decker, Valrico, FL (US)

(21) Appl. No.: 15/187,034

(22) Filed: Jun. 20, 2016

(51) Int. Cl. H04L 29/06; H04L 29/08

(52) U.S. Cl. CPC H04L 63/306; H04L 67/34; H04L 67/10; H04L 63/168; H04L 63/308; H04L 67/02

(57) ABSTRACT

Provided are systems and methods for employing remote forensics and data security services over public and private networks by obtaining full access to digital data from the non-transitory computer-readable media of geographically dispersed computing devices such that the entire physical or logical media from each device is fully accessible to one or more user computers over the network. This is achieved via WebSocket technology implemented in point-to-point connection configurations, WebSocket technology implemented in network based digital data software switch configurations, and in combinations thereof. Application of these systems and methods are generally employed for the purpose of conducting remote examinations and remediation efforts upon electronic data comprising non-transitory computer-readable media on a network accessible computing device. As a few examples, the application of these systems and methods may be applied for the purposes of data sharing, remote computer support, data recovery, data loss prevention, data backup, eDiscovery (electronic discovery), digital forensics, remote monitoring, audit compliance, incident response, security incident remediation, and mobile device data management purposes. Examples of computing devices include, but are not limited to, workstations, laptops, tablets, smart phones, network routers, network switches, mobile computing devices, electronic sensors, and any device comprising the Internet of Things (IoT).

### FIELD OF THE INVENTION

The present invention generally relates to systems and methods for implementing network based remote access between geographically dispersed subject computing devices, to obtain full access to digital data from the non-transitory computer-readable media of geographically dispersed computing devices such that the entire physical or logical media from each device is fully accessible to one or more user computers over public and private networks. This is achieved via WebSocket technology implemented in point-to-point (direct) connection configurations, WebSocket technology implemented in network based digital data software switch implementations, and in combinations thereof. Application of these systems and methods are generally employed for the purpose of conducting remote examinations and remediation services upon electronic data comprising non-transitory computer-readable media on a network accessible computing device. As a few examples, the application of these systems and methods may be applied for the purposes of data sharing, remote computer support, data recovery, data loss prevention, data backup, eDiscovery (electronic discovery), digital forensics, remote monitoring, audit compliance, incident response, security incident remediation, and mobile device data management purposes. Examples of computing devices include, but are not limited to, workstations, laptops, tablets, smart phones, network routers, network switches, mobile computing devices, and any device comprising the Internet of Things (IoT) that contains non-transitory computer-readable media.

This invention uses WebSocket technology implemented as a point-to-point (direct) remote data connectivity solution to obtain full access to digital data from the non-transitory computer-readable media of geographically dispersed computing devices. The invention also incorporates, and improves upon, the software switching capability disclosed in our published U.S. Pat. No. 9,148,418, which allows users to obtain and control access to the non-transitory computer-readable media on virtually any computer device from virtually any location, over public and private TCP/IP (Transmission Control Protocol/Internet Protocol) networks via a software switch appliance. The system and method is improved by utilizing WebSocket technology to implement point-to-point connections directly between user and subject computers. The software switch capability is achieved via the application of WebSocket technology, and is an appliance based software switch. The foundation of that design is that all data flows to or through the software switch under all circumstances. This invention introduces application of WebSocket technology in a point-to-point design implementation that, provided as a standalone capability, facilitates one or more user computers connecting directly to one or more subject computers, simultaneously, without necessarily passing all data to or through an intermediary software switch. The point-to-point capability can also be integrated with the software switch, implementing a capability to programmatically determine and select WebSocket connections that will not flow through the software switch, but will instead be rendered as direct, point-to-point connections. Integrating this invention with our software switching technology adds to the switch the capability to selectively determine whether a particular WebSocket connection is best maintained as a switched connection, or if the connection will be released from the switch and handed off as a point-to-point connection between a user computer and subject computer.

The system and method provide the ability to obtain and control access to the non-transitory computer-readable media of the myriad of existing and forthcoming network capable computing devices, and allows secure, remote access to virtually any computer device, which may remain situated in the device's working environment while being accessed remotely. The capability can be applied in numerous capacities including, but not limited to, data sharing services, remote computer support operations, data recovery, data loss prevention, data backup, eDiscovery (electronic discovery), digital forensics, remote monitoring, audit compliance, incident response, incident remediation, and mobile device data management. As with switched connections, multiple point-to-point WebSocket connections can be established between several devices creating one to one, many to many, one to many, or many to one connection scenarios.

The WebSocket protocol, standardized by the Internet Engineering Task Force (IETF) as RFC 6455, provides for fully bidirectional communications between two devices over a Transmission Control Protocol (TCP) connection. After a successful handshake, the two devices, referred to as clients and hosts in the specification, transfer data back and forth in conceptual units referred to in the specification as “messages”. WebSocket technology creates a persistent connection between clients and hosts, eliminating overhead associated with other protocols and methods, and is thus a suitable protocol for application to transferring large blocks of data over any TCP/IP network, including the Internet.

The invention renders digital data from any logical or physical storage media from a networked computing device, for example a computing device connected to the Internet, to be fully accessible to a second computer on the Internet. Furthermore, because the invention can provide the remote data access in a forensically sound manner, the invention allows individuals, whom may not otherwise be qualified in digital forensic techniques, to identify, preserve, collect and analyze Electronically Stored Information (ESI) in a forensically sound manner over public and private networks when using the invention to deliver forensics or electronic discovery services.

As one example, this can be achieved via a “cloud computing” model whereupon the user obtains, from the Internet, temporary use of shared resources, software, and information for the purpose of rendering the non-transitory computer-readable media of one or more subject computers as fully accessible to one or more secondary computers over the Internet. The “cloud-based” shared resources, software, and information generally comprise a software data switching system. Integrating this invention with the software data switching system adds to the switch the capability to selectively determine whether a particular WebSocket connection is best initiated and maintained as a switched connection, whereupon all data passes through the cloud, or if the particular WebSocket connection would achieve a performance improvement if released from the switch and were initiated and maintained as a point-to-point connection directly between a user computer and subject computer. For example, a user desires to use the invention to connect to a subject computer located on the same Local Area Network (LAN), and a point-to-point connection between the two would be far more bandwidth efficient than a connection initiated and maintained through the software switch. In this case a point-to-point connection would be initiated and maintained directly between the user computer and subject computer, and the data traversing the connection would not pass through the software switch.

### BACKGROUND OF THE INVENTION

While the invention is not limited to the application of computer examination services, the fact that it is suitable for digital forensics services, and remote managed services, highlights the unique nature of this capability. Computer examination services include, but are not limited to, electronic discovery (eDiscovery), digital forensics, incident response, incident remediation, information security, digital investigations, file recovery, system identification, data preservation, data collection and data analysis. In order that computer examination operations produce information that is suitable for use in a court of law, these services must be provided in a manner consistent with accepted practices from the fields of computer forensics and eDiscovery. Computer forensics and eDiscovery are scientific fields that address the identification, preservation, collection and analysis of data stored on computer systems such that the data is suitable for use in a court of law. Electronic discovery (eDiscovery) refers to the discovery of Electronically Stored Information (ESI) in civil litigation proceedings. Those involved in eDiscovery may include computer forensic practitioners, lawyers, IT personnel, and others, yet sound computer forensics practices are employed to the extent that they are reasonable and practical because the data is subject to being used in a court of law.

Computers, in a myriad form of computing devices (e.g. desktops, laptops, tablets, gaming devices, phones, mobile devices, etc.) are increasingly relied upon for personal and business communications, data creation, data management, and in general, as short and long term data repositories. The information that can be found in these data repositories are often sought after to establish innocence or guilt in a court of law, thus the process of identification, preservation, collection and analysis of data stored on subject computer systems must often be accomplished in accordance with procedures that do not preclude the use of the data as evidence in a court of law. This invention enables this to be achieved over public or private networks, such as a company network or the Internet, via two computers that are directly connected (point-to-point) across the network, connected via network based digital data software switch implementations, and in combinations thereof. In this case, the end user must obtain read-only access to the raw (physical) non-transitory computer-readable media devices of the subject computers in order to perform forensically sound digital forensics services.

The information security and incident response fields incorporate acceptable processes and procedures for the identification, preservation, collection, and analysis of computer data, but unlike digital forensics services, these fields also call for remediation capabilities. While a practitioner using the invention for digital forensics services will typically prefer read-only access to the remote data, a practitioner performing security and incident response services may require the ability to write to the remote subject computer. This invention enables this to be achieved over public or private networks, such as a company network or the Internet, via two computers that are directly connected (point-to-point) across the network, connected via network based digital data software switch implementations, and in combinations thereof. In this case, the end user could be granted read-write access to the raw (physical) non-transitory computer-readable media devices of the subject computers in order to perform analysis and remediation services.

Computer forensics, information security monitoring, and incident response analysis can be a very time consuming and expensive process. In most cases it is not practical for a practitioner to take custody of subject computers for analysis. Expending a large effort, in time and money to determine whether or not subject computers contain actionable data is often not practical or economically feasible unless the effort can be conducted upon active systems across public and private networks. Accordingly, there is a growing need for ever more cost effective and efficient remote access to data located on the myriad of network-based computer devices.

There is a growing demand for systems and methods that provide the ability to obtain and control access to the non-transitory computer-readable media of the myriad of existing and forthcoming network capable computing devices. There is a demand for a capability that provides access to digital data on virtually any computer device from virtually any location using an appropriate methodology and system. There is a need for faster, more efficient, and more cost effective methods of accessing the non-transitory computer-readable media of network capable computing devices which can be applied to virtually any network-based file sharing and data access application.

Prior methods of conducting forensic collection, preservation and examination over a communications network are disclosed in our published U.S. Pat. Nos. “7,899,882”, “8,171,108”, “9,037,630” and “9,148,418”, the complete disclosures of which are incorporated herein by reference.

### SUMMARY OF THE INVENTION

The present invention overcomes the physical access challenge and other short-comings of the prior art methods described herein. The invention enhances our existing software switch technology by providing an effective point-to-point technology for obtaining full access to digital data from the non-transitory computer-readable media of geographically dispersed computing devices such that the entire physical or logical media from each device is fully accessible to one or more user computers over public and private networks, allowing secure, remote access to a subject computer, which may remain situated in the computer's working environment.

The invention permits digital data from any logical or physical storage media from a networked computing device, such as a device connected to the Internet, to be fully accessible to a second computer on the Internet. This can be accomplished via a WebSocket connectivity capability allowing either software switched, or point-to-point connections between devices to be established as one to one, many to many, one to many, or many to one connections. As a “one to many” example, the invention permits computer examinations to be conducted remotely upon many geographically dispersed subject computing devices from one user computer, and eliminates the need for a user to have physical access to the subject computing devices to perform the examinations.

Provided are methods and systems for performing network-based point-to-point connections, and digital data software switched connections between geographically dispersed subject and user computing devices. The invention renders digital data from the non-transitory computer-readable media of geographically dispersed subject computing devices to be fully accessible via a second set of one or more user computers on the Internet. User access to the digital data from the non-transitory computer-readable media of one or more geographically dispersed subject computing devices is facilitated via WebSocket point-to-point systems, or software switched systems. In either case, the system will typically be configured to make subject computers accessible to user computers, but with relatively minor and obvious modifications could be configured to permit full bidirectional access among one or many geographically dispersed user and subject computers.

The invention emulates all non-transitory computer-readable media devices on a machine as raw (physical or logical), read-only SCSI devices, whether the devices are inherently SCSI devices or not. The invention translates SCSI and non-SCSI devices such that the SCSI command set is used to establish raw, and if desired read-only connectivity to subject computer devices from a second computer, over a network. As a result, every non-transitory computer-readable media device on a subject computer becomes a SCSI disk rendered on the second user computer, and that SCSI disk is rendered to the second user computer as a raw (physical or logical) non-volatile device. In one embodiment of the invention, the connection between the subject and user computers is established and maintained as a WebSocket point-to-point connection, wherein all data traverses directly between the two computers, including command, control, and data transfer traffic. In another embodiment of the invention, the WebSocket point-to-point connection between the subject and user computers is initiated via a software switch with the capability to programmatically establish WebSocket connections that will not flow through the software switch, but will instead be rendered as direct point-to-point connections. In yet another embodiment of the invention, regardless whether the point-to-point connection between the subject and user computers is initiated via a software switch, or initiated by the user, command and control data traverses between the user and subject computers while data transfer traffic is directed to a third computer selected by the user which facilitates storage of the collected data and may be located anywhere on accessible public or private networks.

The present invention differs from existing remote connection and data sharing methods in a number of ways. Consider as an example, the use of NBD (Network Block Device) to connect to a remote computing device to facilitate the remote collection, preservation, and analysis of computer-based evidence. A Network Block Device (NBD) is a standard remote data storage access protocol, introduced in 1998, that allows a client computer to access a data store on a remote system over a TCP/IP communications network. The NBD connection is a point-to-point connection, established directly between the two computers. NBD connections work well on internal Local Area Network (LAN) connections, but not over most Internet connections due to many factors, including but not limited to commonly implemented networking tools and techniques such as firewalls, filters, proxy devices, Network Address Translation (NAT), and Port Address Translation (PAT). Furthermore, once the client computer has established an NBD connection, the NBD connection is used as though it were a disk drive actually on the client as opposed to somewhere else on the network. The network block device on the server can be an actual hard disk or even a type of file that can be accessed as though the NBD connection were a disk; however, unlike the present invention, using the standard NBD protocol to establish an NBD connection does not render the NBD as a raw, physical disk on the client computer. If an NBD connected non-transitory media is to be identified by the client computer operating system as a full physical disk, then the media must be “translated” to the client computer to be rendered as a full physical disk. One embodiment of the present invention facilitates this translation. The present invention emulates all non-transitory computer-readable media devices on the subject computer allowing them to be rendered as raw (physical or logical), and optionally read-only, SCSI devices to the user computer. As such, the user can obtain full, or read-only access to the raw (physical or logical) non-transitory computer-readable media devices of the subject computers in order that computer examination and other services may be performed. This invention utilizes the WebSocket protocol for connections between user and subject computers. The present invention offers improvements in flexibility and scalability versus existing methods.

The present invention reduces delivery times and costs for the examination and remediation of computing devices by enabling and simplifying the process to be conducted upon geographically dispersed subject computers from a central location, thus significantly reducing the time required of a qualified practitioner in conducting examinations and remediation efforts. This improvement significantly increases the efficiency and affordability of computer examination services. The invention achieves these objectives via systems and methods, using dedicated or shared resources, software, and information to provide access to the non-transitory computer-readable media of remote computing devices on demand over a TCP/IP network.

A Cloud-based architecture embodiment of the invention comprises the following:
1) A software switch management server is available in the cloud to manage user accounts, and for provisioning switch services to numerous customers.
2) One or more Virtual Machine (VM) capable servers (Virtual Machine servers) are located in the cloud, upon which customer dedicated software switch VM servers (software switch servers) can be created on demand.
3) The customer creates a user account on the software switch management server and uses this account to requisition one or more dedicated software switch VM servers on any of the available Virtual Machine servers. For example, a customer may choose to create a software switch VM server on a Virtual Machine server located in the United States of America, and also a software switch VM server on a Virtual Machine server located in Great Britain.
4) The software switch management server provisions the dedicated software switch VM server(s) on the requested Virtual Machine server(s).
5) The customer receives the information and credentials necessary to access and control each of their dedicated software switch VM server(s).
6) User program code is installed and started on the user computer(s). The user program code is configured with information and credentials such that the user computer can connect only with the intended dedicated software switch VM server using that program code.
7) User computer(s) establish a command and control connection to the dedicated software switch VM server via a WebSocket connection using the user program code.
8) Subject program code is deployed and started on the subject computer(s) to which connections are desired. The subject program code is configured with information and credentials such that the subject computer can connect only with the intended dedicated software switch VM server, or optionally via direct point-to-point connections with other computers designated by the user. The subject program code is also configured to control access to the media, as appropriate. For example, the configuration may be crafted to maintain read-only access to the subject computer non-transitory computer-readable media and thus will not permit the user to alter the files or Metadata on the subject computer. The subject program code would thus be constructed to translate commands from a non-transitory computer-readable media device of any type to a read-only SCSI non-volatile media device, and thus could not write to the read-only non-transitory computer-readable media in response to receiving any command including a write command. This establishes the optional read-only capability for the invention, and the capability to present the non-transitory computer-readable media devices on the subject computer as raw (physical or logical) non-volatile computer-readable media devices to the user computer.
9) Subject computer(s) establish a command and control connection to the dedicated software switch VM server via a WebSocket connection using the subject program code.
10) The user instructs the software switch VM server to establish a connection with an available subject computer. A WebSocket connection between the user and software switch VM server is created, a WebSocket connection between the subject computer and software switch VM server is created, and these two connections are patched together by the software switch to create one bidirectional connection between the user computer and subject computer. Optionally, the software switch programmatically determines that the connection is best served via WebSocket connections that will not flow through the software switch, and the connection between the user and subject are rendered as a direct, point-to-point connection.
11) A user utilizes the connection to conduct examination or remediation services over the public or private network upon the subject computer. If the user desires to collect and preserve data from the subject computer for future analysis, the user utilizes the connection to select data on the subject computer to be uploaded directly to the user computer for the collection and preservation of the data. Data is uploaded in a manner that catalogues and preserves the integrity of each file, and file system Metadata, thus permitting the user to identify, preserve, collect and/or analyze the data on one or more subject computers in a forensically sound manner.
12) Non-transitory computer-readable media of the subject computer(s) is available to user computer(s) via multiple WebSocket sessions. This is accomplished either over the Internet via the software switch VM server, which switches all communications and data between user computer(s) and subject computer(s), or optionally via direct point-to-point connection(s) between user computer(s) and subject computer(s) when significant performance improvements can be achieved by direct point-to-point connection(s).
13) The data transferred between the subject computer and user computer will typically be encrypted via accepted encryption technologies. The WebSocket standard addresses this capability natively by incorporating application of the Secure Socket Layer/Transport Layer Security (SSL/TLS) standard and methods. Additionally, one feature of the invention employs encryption methods such as the Advanced Encryption Standard (AES) to secure data traversing WebSocket connections via HTTP, which would not otherwise be encrypted. As another example, WebSocket connections may be tunneled over an encrypted connection via accepted encryption technologies using Virtual Private Network (VPN) standards and methods.
14) The data transferred between the subject computer and user computer will typically be compressed via accepted compression technologies and techniques. Compressing data prior to transmission generally makes more efficient use of the network bandwidth.
15) Upon terminating the connection to any subject computer, the user maintains access to any preserved and collected data, thus providing the user with exclusive and perpetual access to that data for further analysis.
16) The user can output a report from the examination or remediation process. A typical report could include, as examples, subject computer identifying characteristics such as serial numbers and asset tags, subject computer BIOS and system parameters, a listing of installed programs, a listing of mapped network drives, passwords or keys stored in active memory (RAM), and log files documenting user actions taken against the subject computer.
17) The user can make and break switched or direct connections to subject computers for which the user has proper information and credentials, and may also issue a command to stop and remove the subject computer code from the subject computer if desired.

A Local Area Network (LAN) based architecture embodiment of the invention comprises the following:
1) One or more customer dedicated software switch servers are optionally provided to the customer for installation and use in the corporate LAN. The software switch server is optional because the customer can elect not to use a software switch appliance, and can elect to establish only point-to-point connections between user computers and subject computers. This software switch appliance may be, but does not need to be, a Virtual Machine implementation because the Virtual Machine server is dedicated to a single customer, and thus runs as a customer dedicated software switch server.
2) The customer is provided with the necessary subject computer code, user computer code, and product licensing information. The subject computer code and user computer code will be configured to establish point-to-point connections between user computers and subject computers, and will be configured to communicate with a software switch only if the software switch option is elected by the customer, in which case the customer also receives information and credentials to access and control the dedicated software switch.
3) User program code is installed and started on the user computer(s). If a software switch is used, the user program code is configured with information and credentials such that only a user with proper credentials can connect with the dedicated software switch using that program code. The user program code is configured such that only a user with proper credentials can connect with subject computers that are configured with complementary credentials.
4) If a software switch is used, user computer(s) establish a command and control connection to the dedicated software switch via a WebSocket connection using the user program code.
5) Subject program code is deployed and started on the subject computer(s) to which connections are desired. The subject program code is configured with information and credentials such that the subject computer can connect via direct point-to-point connections with user computers, and optionally through software switch server(s). The subject program code is also configured to control access to the media, as appropriate. For example, the configuration may be crafted to maintain read-only access to the subject computer non-transitory computer-readable media and thus will not permit the user to alter the files or Metadata on the subject computer. The subject program code would thus be constructed to translate commands from a non-transitory computer-readable media device of any type to a read-only SCSI non-volatile media device, and thus could not write to the read-only non-transitory computer-readable media in response to receiving any command including a write command. This establishes the optional read-only capability for the invention, and the capability to present the non-transitory computer-readable media devices on the subject computer as raw (physical or logical) non-volatile computer-readable media devices to the user computer.
6) If a software switch is used, subject computer(s) establish a command and control connection to the dedicated software switch via a WebSocket connection using the subject program code.
7) If a software switch is used in the system, the user instructs the software switch to establish a connection with an available subject computer. A WebSocket connection between the user and software switch is created, a WebSocket connection between the subject computer and software switch is created, and these two connections are patched together by the software switch to create one or more bidirectional connections between the user computer and subject computer. Optionally, the software switch programmatically determines that the connection is best served via WebSocket connections that will not flow through the software switch, and directs that the connection between the user and subject be rendered as a point-to-point connection. If a software switch is not used in the system, then the user computer initiates a point-to-point WebSocket connection with the subject computer(s).
8) A user utilizes the WebSocket connections established by this system to conduct examination or remediation services upon the subject computer over public or private networks.
9) If the user desires to collect and preserve data from the subject computer for future analysis, the user utilizes the WebSocket connections to select data on the subject computer to be uploaded directly to the user computer for the collection and preservation of the data. Data is uploaded in a manner that catalogues and preserves the integrity of each file, and file system Metadata, thus permitting the user to identify, preserve, collect and/or analyze the data on one or more subject computers in a forensically sound manner.
10) Non-transitory computer-readable media of the subject computer(s) is available to user computer(s) via multiple WebSocket sessions. This is accomplished either via a direct point-to-point connection between the user(s) and subject(s), or optionally via a software switch that manages and patches WebSocket communications and data between connected user computer(s) and the subject computer(s). In any case, a “connection” between a user and subject computer is accomplished via multiple WebSocket sessions.
11) The data transferred between the subject computer and user computer will typically be encrypted via accepted encryption technologies. The WebSocket standard addresses this capability natively by incorporating application of the Secure Socket Layer/Transport Layer Security (SSL/TLS) standard and methods. Additionally, one feature of the invention employs encryption methods such as the Advanced Encryption Standard (AES) to secure data traversing WebSocket connections via HTTP, which would not otherwise be encrypted. As another example, WebSocket connections may be tunneled over an encrypted connection via accepted encryption technologies using Virtual Private Network (VPN) standards and methods.
12) The data transferred between the subject computer and user computer will typically be compressed via accepted compression technologies and techniques. Compressing data prior to transmission generally makes more efficient use of the network bandwidth.
13) Upon terminating the connection to any subject computer, the user maintains access to any preserved and collected data, thus providing the user with exclusive and perpetual access to that data for further analysis.
14) The user can output a report from the examination or remediation process. A typical report could include, as examples, subject computer identifying characteristics such as serial numbers and asset tags, subject computer BIOS and system parameters, a listing of installed programs, a listing of mapped network drives, passwords or keys stored in active memory (RAM), and log files documenting user actions taken against the subject computer.
15) The user can make and break connections to subject computers for which the user has proper information and credentials, and may also issue a command to stop and remove the subject computer code from the subject computer if desired.

The point-to-point network-based architecture rendition of the invention comprises the following:
1) A customer has one or more subject computers on which they would like to conduct examination or remediation services upon the computer's non-transitory computer-readable media.
2) Specially crafted user program code is installed and started on the user computer(s).
3) Specially crafted subject program code is deployed and started on the subject computer(s) to which connections are desired. The subject program code is configured with information and credentials such that the subject computer can connect only with users and specially crafted user program installations that possess the configured information and credentials. The subject program code is also configured to control access to the media, as appropriate. For example, the configuration may be crafted to maintain read-only access to the subject computer non-transitory computer-readable media and thus will not permit the user to alter the files or Metadata on the subject computer.
4) User computer(s) establish secure command and control connections to the subject computer(s) via one or more WebSocket connections facilitated by the point-to-point connection between the user and subject program codes. Secure WebSocket connections are also used for transferring the data collected from the subject.
5) The subject program code has the ability to maintain read-only access to the subject computer “non-transitory” computer-readable media, and thus has the ability to prevent the user from altering the files or Metadata on the subject computer via the point-to-point connections. The subject program code is constructed to translate commands from a non-transitory computer-readable media device of any type to a SCSI non-volatile computer-readable media device. If the SCSI non-volatile computer-readable media device is configured with the read-only feature enabled, then the subject code cannot initiate a write to non-transitory computer-readable media in response to receiving any command including a write command. This establishes both the read-only capability of the invention, and the capability to present the non-transitory computer-readable media devices on the subject computer as raw (physical) non-volatile computer-readable media devices on the user computer.
6) A user utilizes the point-to-point connection to conduct examination or remediation services over the public or private network upon the one or more subject computers.
7) If the user desires to collect and preserve data from the subject computer for future analysis, the user utilizes the point-to-point connection to select data on the subject computer to be uploaded directly to the user computer for the collection and preservation of the data. Data is uploaded in a manner that catalogues and preserves the integrity of each file, and file system Metadata, thus permitting the user to identify, preserve, collect and/or analyze the data on one or more subject computers in a forensically sound manner.
8) The data transferred between the subject computer and user computer may be encrypted via accepted encryption technologies. The WebSocket standard addresses this capability natively by incorporating application of the Secure Socket Layer/Transport Layer Security (SSL/TLS) standard and methods. Additionally, one feature of the invention employs encryption methods such as the Advanced Encryption Standard (AES) to secure data traversing WebSocket connections via HTTP, which would not otherwise be encrypted. As another example, WebSocket connections may be tunneled over an encrypted connection via accepted encryption technologies using Virtual Private Network (VPN) standards and methods.
9) The data transferred between the subject computer and user computer will typically be compressed via accepted compression technologies and techniques. Compressing data prior to transmission generally makes more efficient use of the network bandwidth.
10) Upon terminating the point-to-point connection to any subject computer, the user maintains access to any preserved and collected data, thus providing the user with exclusive and perpetual access to that data for further analysis.
11) The user can output a report from the examination or remediation process. A typical report could include, as examples, subject computer identifying characteristics such as serial numbers and asset tags, subject computer BIOS and system parameters, a listing of installed programs, a listing of mapped network drives, passwords or keys stored in active memory (RAM), and log files documenting user actions taken against the subject computer.

The present invention provides the following advantages:
1) The user need not obtain physical access to one or more subject computers in order to access data from the non-transitory computer-readable media on subject computers.
2) The user need not travel to the site of one or more subject computers in order to access data from the non-transitory computer-readable media on subject computers if the subject computers can be made accessible to the user computer via public or private networks.
3) The user need not have the one or more subject computers shipped to another location in order to access data from the non-transitory computer-readable media on subject computers.
4) The customer need not forfeit physical control of the subject computer in order for an inspection to be conducted.
5) Using this invention, the time required of an expensive expert resource is minimized for conducting an inspection.
6) Using the invention, the process of identifying, preserving, and collecting the data on one or more subject computers can be accomplished in a forensically sound manner by trusted resources with more limited skill sets than those of an expert in digital forensics or eDiscovery.
7) Forensic imaging of entire hard drives or “non-transitory” computer-readable media can be accomplished over the Internet using this invention, but forensic imaging need not first be conducted in order to perform an inspection in a forensically sound manner.
8) The invention greatly reduces the need to make changes to the network environment in order to achieve a working solution because initial WebSocket connections are initiated from the user and subject computers on TCP/IP ports 80 and 443, which accommodates commonly implemented networking tools and techniques such as firewalls, filters, proxy devices, Network Address Translation (NAT), and Port Address Translation (PAT).
9) Turn-around time to initiate access to data on a subject computer is greatly reduced since integration into existing network architectures is easily accomplished.
10) Full or selected access to active and non-active data on subject hard drives, flash drives, register memory, processor cache, RAM or other non-transitory computer-readable media can be accomplished over any TCP/IP network from any subject location and to any user location using this invention.
11) The non-transitory computer-readable media is available to be accessed in part or in entirety because the invention renders the media devices as raw (physical or logical) non-transitory computer-readable media devices on the user's computer.
12) Access to subject computer data can be provided in a secure and authenticated manner to authorized users.
13) The data that the user has uploaded is available for exclusive and perpetual access to the user, or to whomever the user chooses to allow access. The user maintains the ability to authenticate and identify the source of the uploaded data, and thus can handle the data in accordance with accepted evidence handling procedures, such as the Federal Rules of Evidence commonly applied in the United States of America. As such, the user can maintain a chain of custody over the collected data.
14) The solution is highly scalable as there is virtually no limit to the number of WebSocket connections that can be created to serve an unlimited number of users and subjects.
15) Scalability is enhanced when used in conjunction with our software switching technology, disclosed in our published U.S. Pat. No. 9,148,418. Our software switching technology can selectively determine whether a particular WebSocket connection is best maintained as a switched connection, or if the connection will be released from the switch and handed off as a point-to-point connection between a user computer and subject computer.
16) The solution is bandwidth efficient, and typically uses compression technology to maximize bandwidth efficiency.
17) The solution is secure, and typically uses standard encryption technology and practices to protect data in transit.

### BRIEF DESCRIPTION OF THE DRAWINGS

FIG. 1 illustrates the software switch media access system deployed as a cloud-based service according to the present invention.

FIG. 2 illustrates the software switch media access system deployed as a customer dedicated appliance solution in a LAN-based (Local Area Network-based) scenario according to the present invention.

FIG. 3 illustrates a point-to-point design implementation in use in a one to many connection configuration, provided as a standalone capability, illustrating one user computer connecting directly to two subject computers, without incorporating a software switch media access system.

FIG. 4 illustrates one rendering of the invention employed as a user application. This screen capture shows a management console presenting several subject devices available for inspection. In this screen capture, the subject device “x64-2k8r2-sub” is presenting two (2) logical volumes, physical memory (pmem), and four (4) physical disks for inspection, and “disk-1” has been mounted using the invention to make it available to the examiner for inspection. This figure does not reveal whether the actual connection is a switched or point-to-point connection.

FIG. 5 illustrates a method according to the present invention that employs switched or point-to-point WebSocket connections to engage bidirectional communications between user and subject computers, and whereupon every non-transitory computer-readable media device on a subject computer becomes a SCSI disk rendered to the user computer as a raw (physical or logical) non-transitory computer-readable media device.

FIG. 6 illustrates a flow chart of an exemplary method according to the present invention rendered via a “switched connection” model.

FIG. 7 illustrates a flow chart of an exemplary method according to the present invention rendered via a “direct connection” model.

### DETAILED DESCRIPTION OF THE INVENTION

In the following description, for purposes of explanation and not limitation, specific details are set forth, such as particular networks, communication systems, computers, terminals, devices, components, techniques, storage devices, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, computers, digital devices, storage devices, components, techniques, data and network protocols, software products and systems, development interfaces, operating systems, and hardware are omitted so as not to obscure the description of the present invention.

The invention will now be explained with reference to the attached non-limiting Figures. The operations described in Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

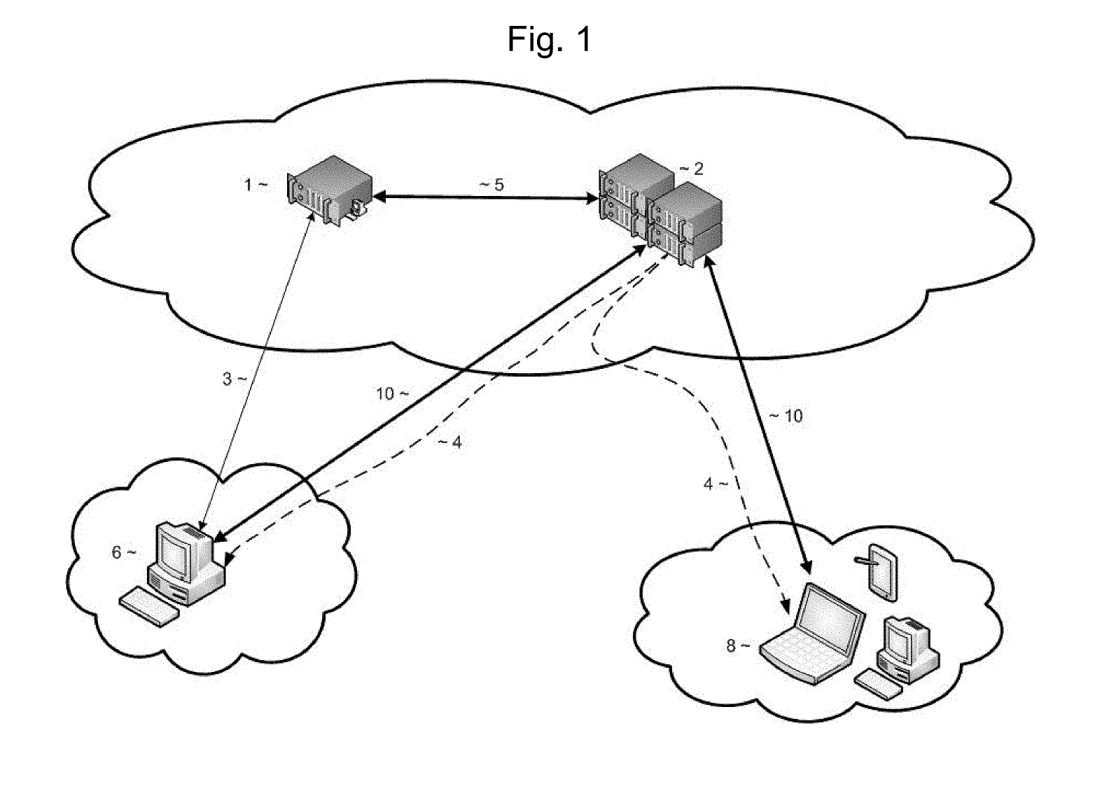

As shown in FIG. 1, the cloud-based computer system comprises at least one computer system, a “software switch server” 2. The term “cloud-based” is used in the broadest sense to mean any computer connected to the Internet. For the system to allow multiple customers to be served by the software switch server 2, the cloud-based computer system comprises at least one additional computer system, a “software switch management server” 1. The software switch server 2 and the software switch management server 1 are on separate computers, as shown in FIG. 1. While the invention is explained with reference to a separate software switch server 2 and software switch management server 1, the software switch management server 1 is used only in the cloud-based architecture to manage user accounts and for provisioning and de-provisioning software switch VM's (software switch Virtual Machine servers 2) when multiple software switch servers 2 are to be created and used to service multiple customers.

A preferred cloud-based architecture is shown in FIG. 1. A software switch management server 1 is available to manage user accounts, and for provisioning and de-provisioning software switch Virtual Machine (VM) servers that are created on a Virtual Machine server 2. Virtual Machine servers 2 are located in the cloud, upon which customer dedicated software switch VM servers can be created on demand. A customer (in this case a user computer 6) can communicate with the software switch management server 1 to purchase software switch services via a user account using the command and control connection 3. The software switch management server 1 provisions a dedicated software switch VM server on the requested Virtual Machine server 2 over a command and control connection 5. The user computer 6 then receives the necessary information and credentials to access and control the dedicated software switch VM server over a command and control connection 3. The user program code is then installed and started on the user computer(s) 6, whereupon the user computer(s) 6 establish a command and control connection 10 to the dedicated software switch VM server 2. The subject program code is deployed and started on the subject computer(s) 8, whereupon each subject computer 8 establishes a command and control connection 10 to the dedicated software switch VM server 2. The subject program code is configured with information and credentials such that subject computer(s) 8 can connect only with the intended dedicated software switch VM server 2. The user instructs the software switch VM server 2 to establish a connection with an available subject computer 8 which creates a secure bidirectional data connection 4 between the user computer 6 and subject computer 8 via the software switch VM server 2. This bidirectional data connection 4 is a software switch connection between the two devices over which the non-transitory computer-readable media of the subject computer is made fully accessible to the user computer over the corporate network and the Internet. The connections are typically encrypted for security, and data traversing the connection may also be compressed for efficient use of the available upload and download bandwidth. The user computer 6 starts, stops, and controls software switch connections with subject device(s) 8 via the dedicated software switch VM server 2. There is no limit to the number of software switch VM servers 2 that can be created in this model. FIG. 1 presents one software switch VM server 2 serving one user computer 6 and one subject computer 8, but as a practical example, thousands of software switch VM servers could be created to serve thousands of users 6 and subjects 8.

The registered customer can purchase temporary rights to use the system, which is typically delivered as a service via a cloud computing model, but can be deployed for exclusive use on a private network if cloud-based systems are not desired. Internet access is a prerequisite to use the system. As an example, the registered customer might be a lawyer representing a client in a civil lawsuit. That lawyer may need to inspect his client's subject computer(s) 8 for documents responsive to a discovery request in the litigation. That lawyer could use the systems to inspect his client's subject computer(s) 8 over the Internet from any user computer 6 via a software switch server 2. In this representative configuration there is no option to engage point-to-point connections between user and subject computers, thus the customer (user computer 6) can only connect to the subject computer(s) 8 via the software switch server 2, and cannot directly connect to the subject computer(s) 8. Subject computer(s) 8 are selected for inspection, and subject program code is deployed to one or more subject computers 8. When executed, the subject program code provides communications via a communication code to the software switch server 2. The subject computer 8 is then connected to the software switch server 2 so that the customer on the user computer 6 can access information on the subject computer 8 via the software switch server 2. This permits the customer to collect data from subject computers for later retrieval and analysis.

User initiated WebSocket command and control connections 10 with the software switch 2 permit each User 6 to start, stop, and otherwise control their connections to subject devices via the dedicated software switch 2. Subject initiated WebSocket command and control connections 10 to the software switch 2 permit subjects to receive and respond to commands from the user. The service can comprise any number of explicit actions or instructions, but can be used to collect data from the subject computer(s) 8, and will store the collected data in a forensically sound manner to a storage location available to user computer 6. As an example, the customer (user) can enter a request into the user computer 6 to obtain files and file listings, including deleted files, from the subject computer 8. The software switch server 2 will pass the instruction to the subject computer 8 to copy the requested data directly to user computer 6. The copied data includes the files along with their original file system Metadata, if any. The communication protocols used can prevent the software switch server 2 from altering the data on the subject computer(s) 8. Thus, the original file system Metadata would not be altered on the subject computer(s) 8, and would be forensically preserved at the time of collection and stored in the non-volatile memory on the user computer 6. When the service actions are complete, the collected data is accessible to the customer for ongoing inspection and analysis.

Upon review of the stored data, the customer may require additional inspections be performed in order to obtain additional data from one or more subject computer(s) 8. The customer would continue to use the system in the same manner as described above until the inspection effort is completed.

At the completion of the forensic analysis, a report can be outputted.

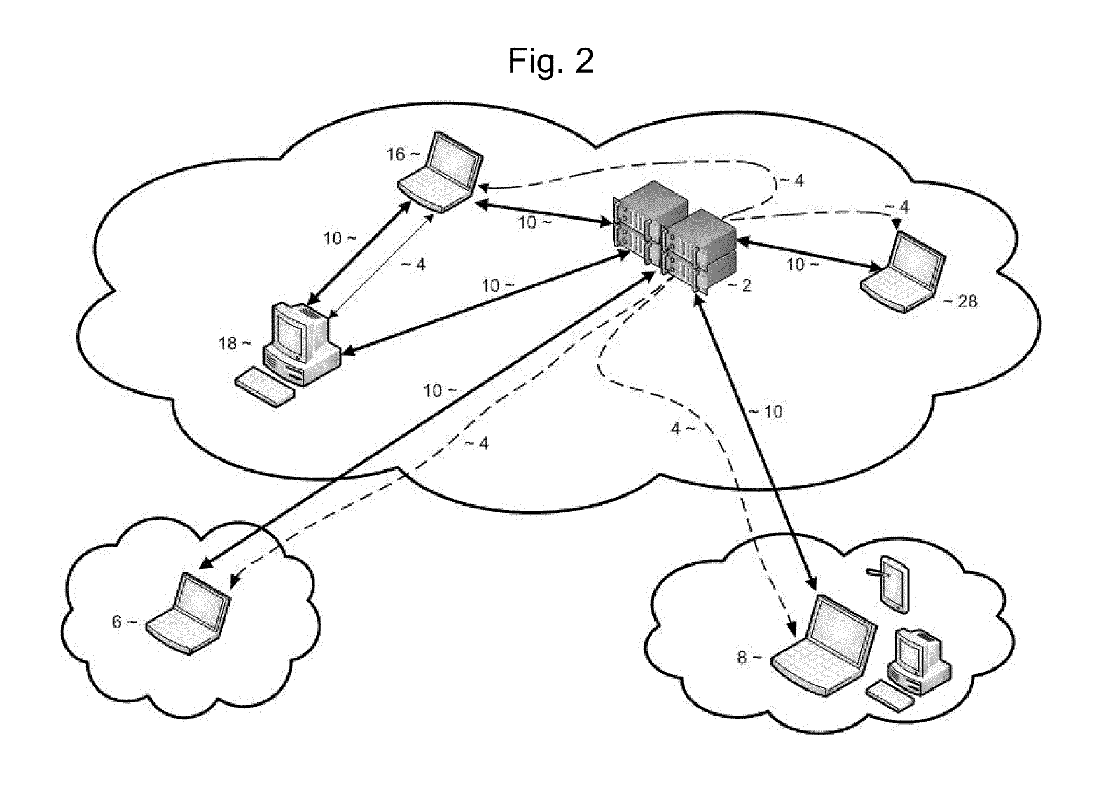

FIG. 2 illustrates the software switch media access system deployed as a customer dedicated appliance solution in a LAN-based (Local Area Network-based) scenario according to the present invention. The Software Switch 2 server is implemented as a dedicated appliance solution in a company network. In this example, several connections have been established by Remote User 6 and Local User 16 for a number of purposes.

FIG. 2 shows an example with several switched connections on a Software Switch 2 server appliance employed in a corporate environment. The Software Switch 2 server may or may not use a VM implementation. Command and control connections 10 are also shown in this example.

As shown in FIG. 2, a software switch connection has been established between Remote User Computer 6 and Remote Subject Computer 8 via the Software Switch 2. Such a connection would be established, for example, to facilitate a corporate examiner (user) conducting an investigation on a company subject computer located at a remote location. The connections are typically encrypted for security, and data traversing the connection may also be compressed for efficient use of the available upload and download bandwidth.

As shown in FIG. 2, software switch connections have been established between Remote Computer User 6, and Remote Subject Computer 8 via the Software Switch 2. The several computer types shown for Remote Subject Computer 8 illustrate that the computer device may be any type of device comprising the Internet of Things (IoT) that contains non-transitory computer-readable media. The Software Switch 2 connections from Remote Computer User 6 to Remote Subject Computer 8 would permit the remote user to access Remote Subject Computer 8 data from anywhere on the Internet. This scenario enables secure examination and remediation of company computers regardless of their location, and regardless whether they are located on the LAN or over the Internet.

As shown in FIG. 2, software switch data connections 4 have been established between Local User Computer 16, and Local Subject Computer 28 via the Software Switch 2. The Software Switch 2 data connections 4 from Local User Computer 16 to Local Subject Computer 28 permit the Local User Computer 16 to access Local Subject Computer 28 data via the company Local Area Network (LAN). This scenario exemplifies secure examinations of company computers located on the LAN. Other scenarios will be presented exemplifying secure examinations of company computers regardless of their location, regardless whether they are located on the LAN or over the Internet.

As shown in FIG. 2, a direct point-to-point connection has been established between Local User Computer 16, and Local Subject Computer 18. FIG. 2 further illustrates how this connection can be achieved in multiple scenarios in accordance with the present invention. In one scenario, the Local User Computer 16 establishes a direct point-to-point connection to the Local Subject Computer 18 without utilizing the Software Switch 2, whatsoever. In this case only the command and control connection 10 and data connection 4 are used that are shown going directly between Local User Computer 16 and Local Subject Computer 18. In another scenario, Local User Computer 16 is utilizing the Software Switch 2, and desires to connect to Local Subject Computer 18. The Software Switch 2 has programmatically determined that the data connection is best served via WebSocket connections that will not flow through the Software Switch 2, and directs that the connection between the user and subject be rendered as a point-to-point connection, thereby establishing the direct point-to-point connection. In this case the command and control connection 10 and data connection 4 are used that are shown going directly between Local User Computer 16 and Local Subject Computer 18, as well as the command and control connections 10 that are shown going from Local User Computer 16 and Local Subject Computer 18 to the Software Switch 2.

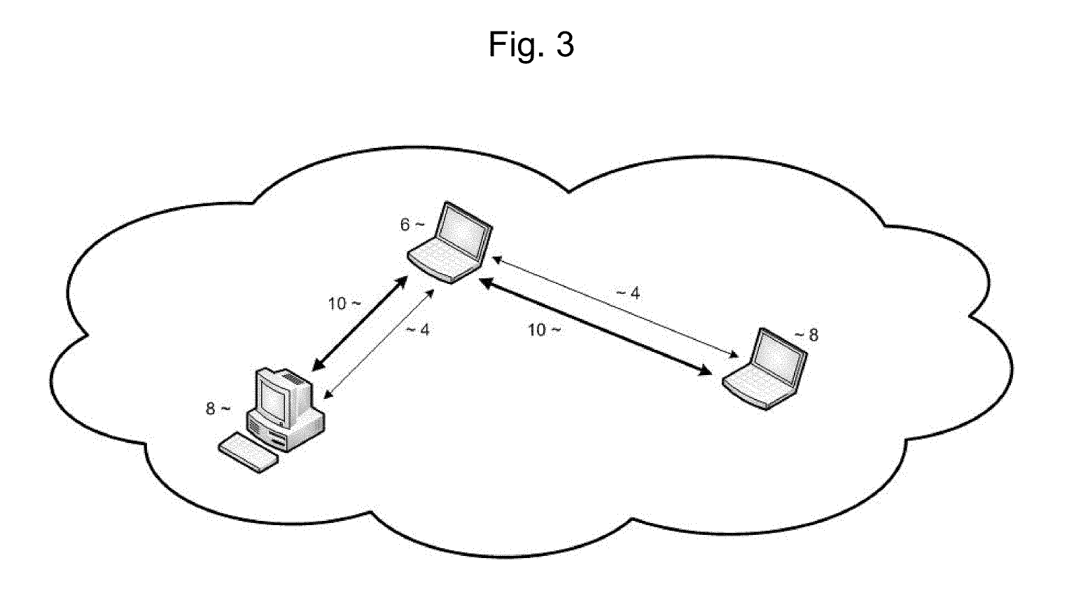

FIG. 3 illustrates the invention used in a scenario that does not utilize an intermediary software switch, thus only point-to-point connections are established between a User Computer 6 and Subject Computer(s) 8. FIG. 3 further illustrates the User Computer 6 collecting and preserving data from the Subject Computers 8 for future analysis, wherein the user utilizes the point-to-point connection to select data on the subject computer to be uploaded directly to the user computer for the collection and preservation of the data. User Computer 6 initiated WebSocket command and control connections 10 permit the user to start, stop, and otherwise control the connections to Subject Computer 8 devices, and permit Subject Computer 8 devices to receive and respond to commands from the user. The service can comprise any number of explicit actions or instructions, but can be used to collect data from the Subject Computer(s) 8, and will store the collected data in a forensically sound manner to a storage location available to the User Computer 6. As an example, the customer (user) can enter a request into the User Computer 6 to obtain a copy of all deleted files for which entries remain in the file system tables on the Subject Computer(s) 8. The Subject Computer 8 responds to the instruction and sends the requested data to User Computer 6. The data includes the files along with their original file system Metadata. The communication protocols used can prevent User Computer 6 actions from altering any data on the Subject Computer(s) 8. Thus, the original file system Metadata would not be altered on the Subject Computer(s) 8, and would be forensically preserved at the time of collection and stored in the non-volatile memory on the User Computer 6. When the service actions are complete, the collected data is accessible to the customer's User Computer 6.

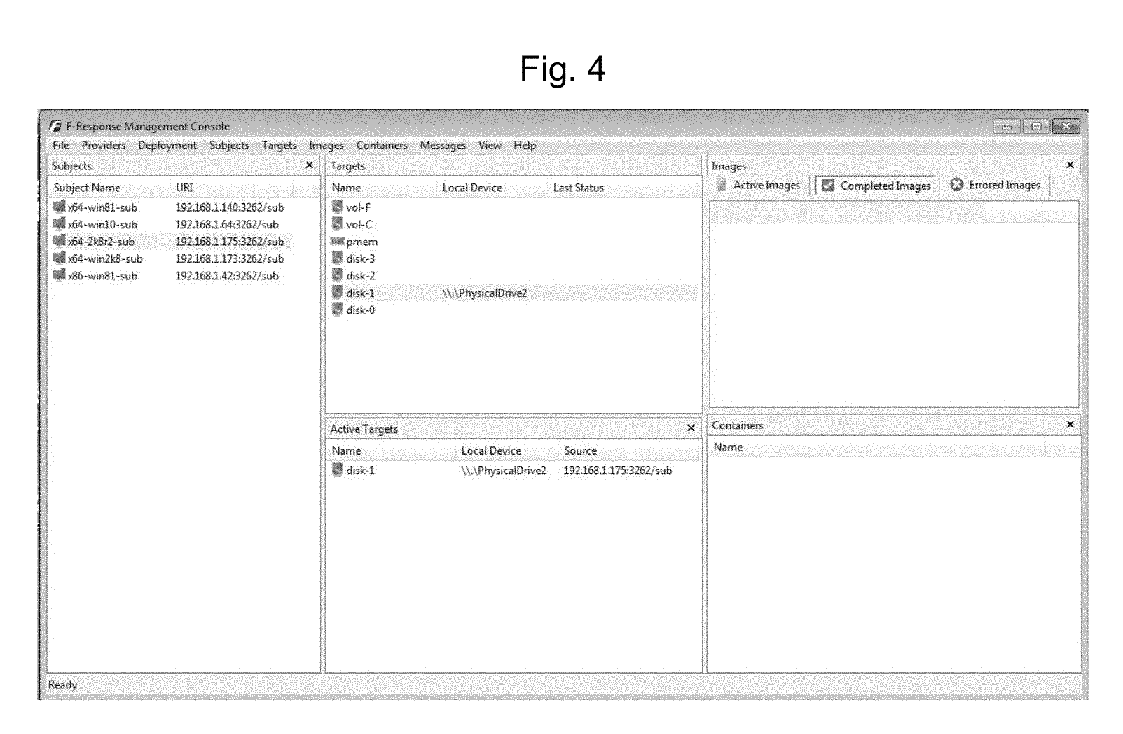

FIG. 4 illustrates one rendering of the invention employed as a user application. This is a screen capture that shows a management console presenting several subject devices available for inspection. In this screen capture, the subject device “x64-2k8r2-sub” is presenting two (2) logical volumes, physical memory (pmem), and four (4) physical disks for inspection, and “disk-1” has been mounted using the invention to make it available to the examiner for inspection. This figure does not reveal whether the actual connection is a switched or point-to-point connection.

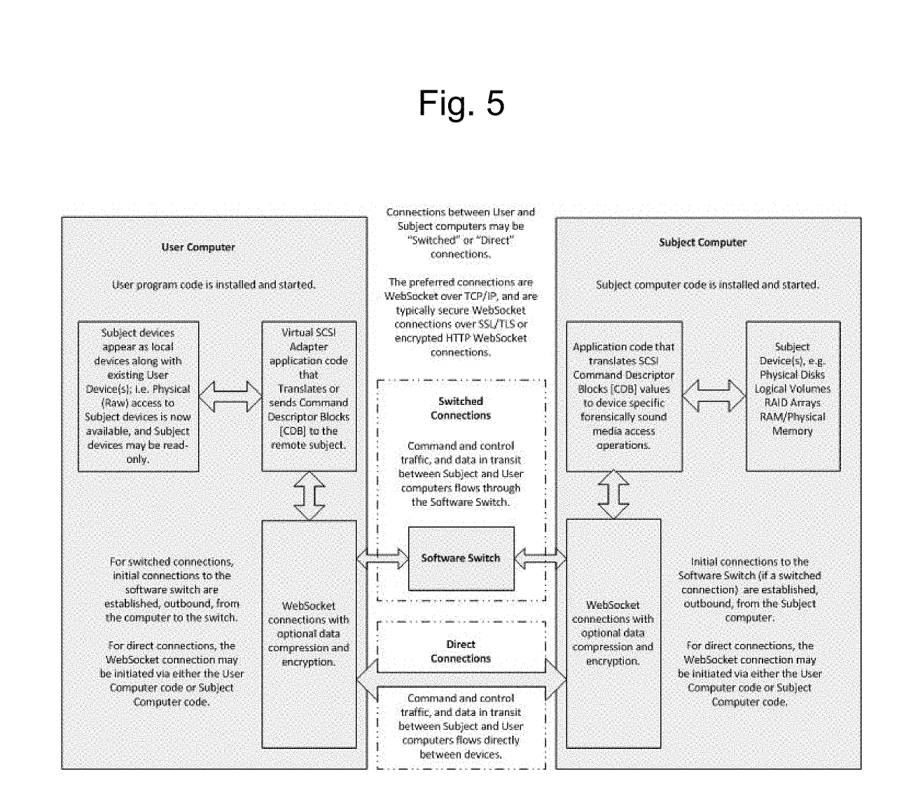

FIG. 5 illustrates a method according to the present invention that employs switched or point-to-point WebSocket connections to engage bidirectional communications between user and subject computers, and whereupon every non-transitory computer-readable media device on a subject computer becomes a SCSI disk rendered to the user computer as a raw (physical or logical) non-transitory computer-readable media device.

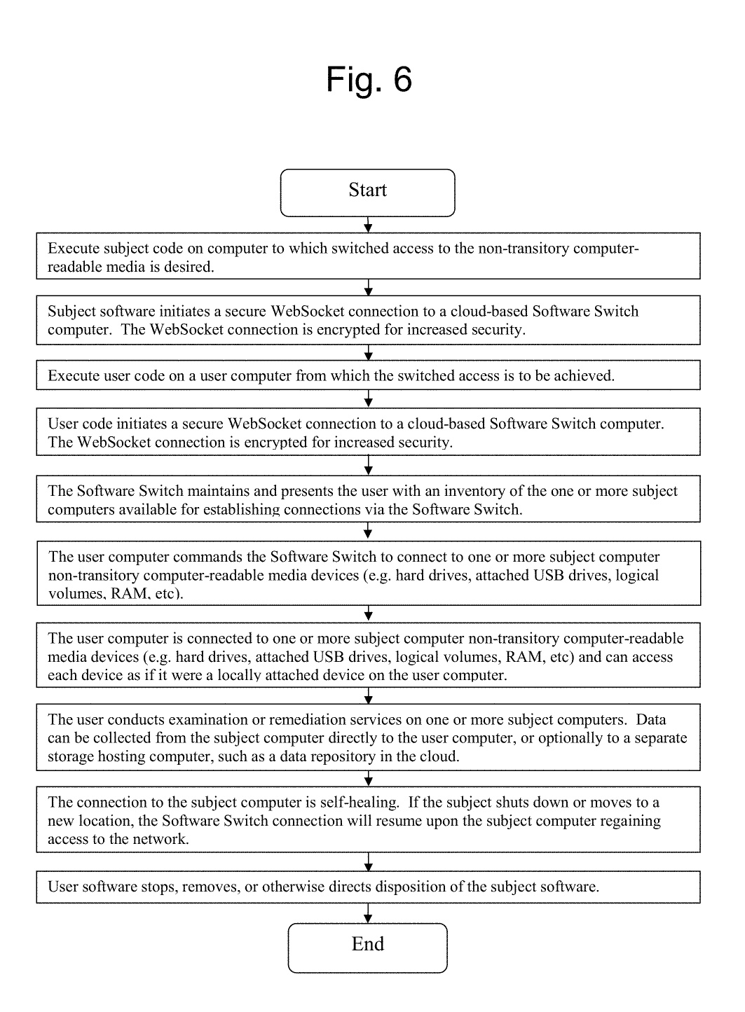

FIG. 6 illustrates a flow chart of an exemplary method according to the present invention rendered via a “switched connection” model.

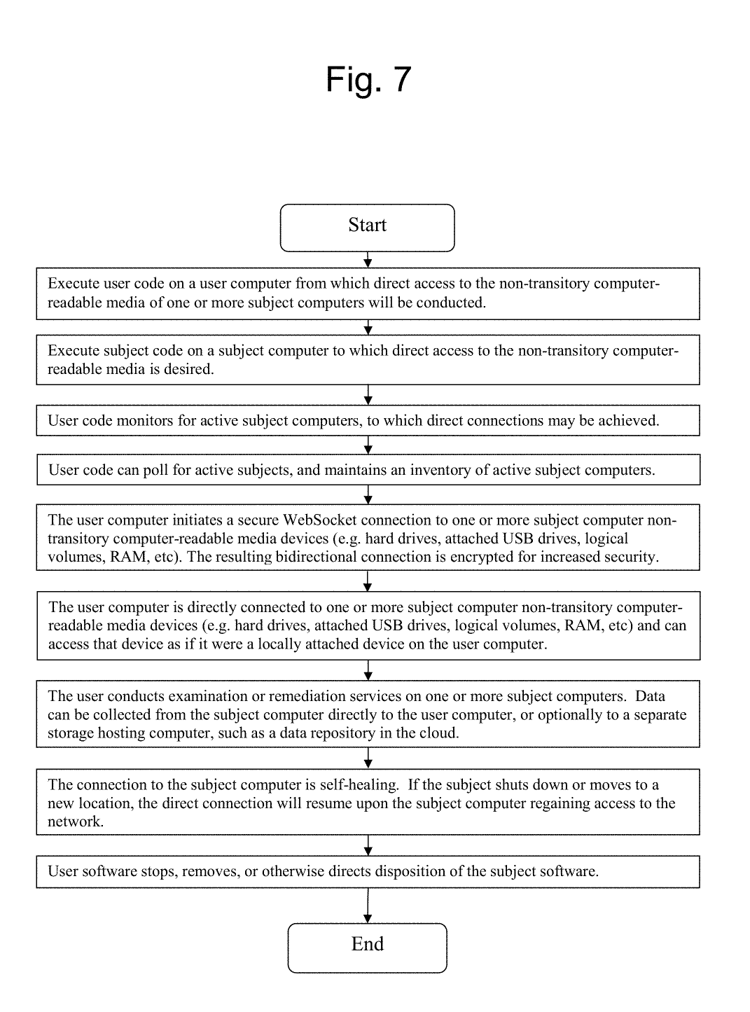

FIG. 7 illustrates a flow chart of an exemplary method according to the present invention rendered via a “direct connection” model.

Definitions for terms used herein are provided below.

Authenticated: Having completed the process of verifying the digital identity of the sender of a communication, such as a request to log in.

Availability: The degree to which data residing on a computer system is available to the user(s) who needs the data.

Cloud-based command and control computer: A Cloud-based command and control computer is a cloud computing service located on the Internet, or “in the Cloud”, that runs command and control software. The command and control software manages connections and communications between the many customers that have user and subject computers that may be connected at any time. This service can incorporate a model of networked online computers which may or may not be hosted by third parties.

Cloud Computing: Cloud Computing is Internet-based computing, whereby shared computer resources, software, storage space, and information, are provided to computers and other devices on demand over a suitable communications network.

Communications network: A network of telecommunications links and nodes arranged so that messages may be passed from one part of the network to another over multiple links and through various nodes. Examples include the Internet, local area networks, wide area networks, wireless networks, and the Public Switched Telephone Network.

Confidentiality: Ensuring that information is accessible only to those authorized to have access.

Drive: A device for the mass storage of computer data; e.g. hard drive, thumb drive, flash drive, solid state drive, etc.

eDiscovery (Electronic Discovery): eDiscovery refers to the discovery of electronically stored information (ESI) in the pre-trial phase of a lawsuit. Discovery refers to the means by which each party to a lawsuit can obtain evidence from the opposing party by means of various discovery devices, including, but not limited to, evidence that exists in the form of ESI.

ESI (Electronically Stored Information): Per the Federal Rules of Civil Procedure (FRCP), ESI is understood to be information created, manipulated, communicated, stored, and best utilized in digital form, requiring the use of computer hardware and software.

Forensically Sound: Forensically sound practices are those that do not violate the rules of evidence accepted by a court (e.g. Federal Rules of Evidence (FRE) in Courts of the United States of America). To be forensically sound, ESI (Electronically Stored Information) must be processed such that conclusions reached via analyzing the data can be used as evidence in a court of law. As one example, ESI collected for use in a USA court of law is to be processed in such a manner that the data can be identified and authenticated, as mandated by the FRE.

Forensics: A scientific, systematic inspection conducted such that the results of the inspection can be used as evidence in a court of law.

Integrity: Ensuring that information is alterable only by those authorized to do so.

Internet: The worldwide, publicly accessible network of interconnected computer networks that transmit data by packet switching using the standard Internet Protocol (IP).

Internet of Things (IoT): The interconnection of computing devices that may be embedded in almost any animate or inanimate object, including living and non-living entities, enabling them to send and receive data over the Internet.

Raw storage media access: Provision of access at block-addressing (raw) level, leaving it to attaching systems to manage data or file systems on the attached media. When raw storage media access is provided to computer storage media, then complete access to all information on the subject media may be obtained.

Read-only: If read-only access is provided to computer storage media, then it is not possible to write to the media given the provided access.

Secure: Sound security practices have been applied to reasonably protect the confidentiality, integrity, and/or availability of a computer resource.

Small Computer System Interface (SCSI): A term for interface standards developed by the International Committee on Information Technology Standards (INCITS) Technical Committee “T10”. T10 is responsible for SCSI storage interfaces and SCSI architecture standards (SAM, SAM-2, and SAM-3), which are used by SCSI, SAS, Fibre Channel, SSA, IEEE 1394, USB, and ATAPI. T10 is a Technical Committee of the International Committee on Information Technology Standards (INCITS) [http://www.incits.org]. INCITS is accredited by, and operates under rules that are approved by, the American National Standards Institute (ANSI) [http://www.ansi.org].

Subject Computer: The computer system upon which remote access to the non-transitory computer-readable media is rendered is the subject computer.

WebSocket: The WebSocket protocol, standardized by the IETF as RFC 6455, provides for fully bidirectional communications between two devices over a TCP connection. The IETF describes WebSockets in the Abstract of the RFC 6455 standard as follows:
“The WebSocket Protocol enables two-way communication between a client running untrusted code in a controlled environment to a remote host that has opted-in to communications from that code. The security model used for this is the origin-based security model commonly used by web browsers. The protocol consists of an opening handshake followed by basic message framing, layered over TCP.”

Cloud Computing is Internet-based computing, whereby shared computer resources, software, storage space, and information, are provided to computers and other devices on demand over a suitable communications network. The invention makes use of existing cloud computing technologies via one or more cloud-based computing servers, and via one or more cloud-based data-repository computers.

Internet protocols used in the invention include the Hypertext Transport Protocol (HTTP) [RFC7540], and the related Transport Layer Security (TLS) [RFC6176] and Secure Socket Layer (SSL) [RFC6101] protocols. HTTP is the foundation of data communication for the World Wide Web. TLS and SSL are information security protocols that allow client/server applications to communicate in a way that is designed to prevent eavesdropping, tampering, or message forgery. There are various versions of TLS and SSL, and standard practice will be used to negotiate the specific protocol version to use to secure the digital data traversing the software switch and point-to-point Websocket connections. WebSocket Protocol [RFC6455] connections, which also incorporate the above mentioned protocols, provide for fully bidirectional communications between two devices over a TCP connection. The present invention makes use of this prior art to securely and efficiently transport electronically stored information (ESI) and system command and control traffic over the Internet, between subject computers and the software switch, between client (aka user) computers and the software switch, and for point-to-point connections between user and subject computers. By default, the WebSocket Protocol [RFC6455] uses port 80 for regular WebSocket connections and port 443 for WebSocket connections tunneled over Transport Layer Security (TLS). Additionally, one feature of the invention employs encryption methods such as the Advanced Encryption Standard (AES) to secure data traversing WebSocket connections via HTTP, for regular WebSocket connections that typically use port 80 which would not otherwise be encrypted.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

We claim:

1. A method of performing Internet based examination and remediation services upon a subject computer having a non-transitory computer-readable media comprising:
executing on a software switch server a switch control program code configured to provide bidirectional communications via a communication protocol;
executing on a subject computer a subject program code configured to provide bidirectional communications via a communication protocol;
establishing a bidirectional connection over a communications network between the software switch and the subject computer via the communication protocol;
executing a user program code on a user computer configured to provide bidirectional communications via a communication protocol;
establishing a bidirectional connection over a communications network between the software switch and the user computer via the communication protocol;
establishing a bidirectional connection over a communications network between the subject computer and user computer via the software switch, wherein no direct connection between the user computer and the subject computer is established;
establishing a bidirectional connection over a communications network between the subject computer and user computer, wherein a direct connection between the user computer and the subject computer is established;
executing commands from the user computer via the software switch server and to the subject computer which directs the subject computer to copy selected data stored in a non-transitory computer-readable media memory of the subject computer to a non-volatile memory on the user computer in a manner that catalogues and preserves the integrity of the data, wherein the communication protocol operates in accordance with a communication protocol standard that permits transmission of one or more write commands for writing data to a non-volatile memory, wherein the subject program code is configured to respond to at least one protocol command in accordance with the communication protocol standard, wherein the subject program code is optionally configured to not write data to the non-transitory computer-readable media of the subject computer in response to receiving the one or more write commands of the communication protocol standard from the user computer;
establishing a secure, encrypted software switch connection over a communications network between the subject computer and the user computer;
performing an examination, forensic analysis or eDiscovery process of the data stored on the subject computer via the software switch connection to the user computer; and
outputting a report based on the examination, forensic analysis or eDiscovery process.

2. The method according to claim 1, wherein the subject program code is configured to not write data to the non-transitory computer-readable media of the subject computer in response to receiving the one or more write commands of the communication protocol standard from the user computer.

3. The method according to claim 1, further comprising logging onto a website using the user computer, registering information on the website, and downloading the client program code from the website.

4. The method according to claim 1, further comprising downloading the subject program code from the cloud-based computer to the subject computer over the Internet.

5. The method according to claim 1, wherein the only connection between the user computer and the subject computer is via the software switch server.

6. The method according to claim 1, wherein the communication protocol is a non-proprietary communication protocol and the communication protocol standard is a non-proprietary communication protocol standard.

7. The method according to claim 1, wherein the computer protocol comprises the WebSocket protocol, and the method further comprises exchanging encrypted communications over the Internet via SSL/TLS.

8. The method according to claim 1, wherein the bidirectional communication protocol comprises the WebSocket protocol.

9. The method according to claim 1, wherein the bidirectional communication protocol comprises encrypted communications over a communications network via HTTP.

10. The method of claim 1, wherein the forensic analysis is conducted in a manner that is suitable for use in a court of law.

11. The method of claim 1, wherein the forensic analysis is conducted such that the existing files or file system Metadata on the subject computer is not altered.

12. The method of claim 1, further comprising copying file system Metadata from the subject computer and maintaining the file system Metadata during collection via the user computer.

13. The method of claim 1, further comprising providing a computer file listing of all computer files, including deleted files for which entries remain in the file system tables of the subject computer, in the report.

14. The method of claim 1, further comprising conducting the forensic analysis such that the original ESI file system Metadata is not altered on the subject computer and is forensically preserved at the time of collection on the user computer.

15. The method of claim 1, further comprising collecting a forensic image of the subject computer to the user computer via the software switch.

16. The method of claim 1, further comprising collecting a forensic image of the subject computer to the user computer via a direct connection.

17. The method of claim 1, further comprising selecting and uploading data comprising at least one of file system Metadata date and time information, file name, folder name, file extension, and keyword searching from the subject computer to the user computer.

18. The method of claim 1, further comprising conducting the forensic analysis without direct assistance from an expert forensics practitioner.

19. A method of performing Internet based examination and remediation services upon a subject computer having non-transitory computer-readable media comprising:
executing on a software switch server a software switch program code configured to provide bidirectional communications via the communication protocol;
executing on the subject computer a subject program code configured to provide bidirectional communications via a communication protocol;
establishing a bidirectional connection between the subject computer and the software switch server via the communication protocol;
executing a client program code on a user computer configured to provide bidirectional communications via the communication protocol;
establishing a bidirectional connection between the user computer and the software switch server;
executing commands to the subject computer from the user computer which may traverse an established software switch server connection, or may be traverse an established direct connection, and direct the subject computer to copy selected data from a non-transitory computer-readable media of the subject computer to a non-volatile memory on the user computer in a manner that catalogues and preserves the integrity of the data, wherein the communication protocol operates in accordance with a communication protocol standard that permits transmission of one or more write commands for writing data to a non-volatile memory, wherein the subject program code is configured to respond to at least one protocol command in accordance with the communication protocol standard, wherein the subject program code is optionally configured to not write data to the non-transitory computer-readable media of the subject computer in response to receiving the one or more write commands via the communication protocol standard;
performing an examination, forensic analysis or eDiscovery process of the data stored on the subject computer via the software switch connection to the user computer; and
outputting a report based on the examination, forensic analysis or eDiscovery process.

20. The method of claim 19, wherein the subject program code is optionally configured to not write data to the non-transitory computer-readable media of the subject computer in response to receiving the one or more write commands via the communication protocol standard.

21. The method of claim 19, further comprising selecting and uploading data comprising at least one of file system Metadata date and time information, file name, folder name, file extension, and keyword searching from the subject computer to the user computer through the software switch server.

22. A computer program product, comprising one or more computer usable media having a computer readable program code embodied therein, the computer readable program code adapted to be executed by a subject computer, a software switch server, and a user computer to implement a method of performing a forensic investigation or eDiscovery process of the subject computer having a non-transitory computer-readable media, the computer program product comprising:
a software switch program code for execution by the software switch server;
a subject program code segment for execution by the subject computer; and
a user program code segment for execution by the user computer, wherein the subject program code and the software switch program code are executable to establish a bidirectional connection between the subject computer and the software switch server via a communication protocol, wherein the software switch program code and the user program code are executable to establish a bidirectional connection between the user computer and the software switch server via a communication protocol, wherein the subject program code is executable to respond to commands in accordance with the communication protocol standard; wherein the subject program code is executable to not write data to the non-transitory computer-readable media in response to receiving the one or more write commands via the communication protocol standard, wherein the subject program code is executable to copy selected data from the non-transitory computer-readable media of the subject computer to the non-volatile memory of the user computer via the software switch server in a manner that catalogues and preserves the integrity of the data, and wherein the user program code is executable to perform a forensic analysis or eDiscovery process of the data stored on the subject computer via the connection from the user computer through the software switch server.

23. The product according to claim 22, wherein the program code is executable to provide a direct connection between the user computer and the subject computer.

24. The product according to claim 22, wherein the cloud-based computer comprises a software switch server, the software switch program code being executable on the software switch server, and the user program code is executable to provide a connection between a user computer and the software switch server, and the subject program code is executable to provide a connection between a subject computer and the software switch server, and the user directs the software switch computer to establish a connection between the user computer and the subject computer.

25. The product according to claim 24, wherein the user program code is executable to provide a connection between the user computer and the software switch server.

26. The product according to claim 24, wherein the subject program code is executable to provide a connection between the subject computer and the software switch server.

27. The product according to claim 24, wherein the program code is executable to provide a software switched connection between the user computer and the subject computer.

28. The product according to claim 24, wherein the program code is executable to provide a direct connection between the user computer and the subject computer.

29. The product according to claim 24, wherein the user directs the software switch server to establish a software switch connection between the subject computer and user computer so that the data copied from the subject computer is stored at the user computer.

30. The product according to claim 24, wherein the subject program code is executable to provide a direct connection between the subject computer and the user computer.

31. A computer system constructed to perform examination and remediation services upon a subject computer having a non-transitory computer-readable media comprising:
a software switch server constructed to provide bidirectional communications via a communication protocol over the Internet with the subject computer and a user computer; and
a cloud-based software switch server constructed to provide bidirectional communications via a communication protocol over the Internet with the subject computer and user computer, the user computer comprising a non-volatile memory constructed to catalogue and preserve the integrity of data stored thereon, the subject computer comprising a non-volatile memory to which remote access by the user is desired, the software switch server being constructed so that the user directs the software switch server to establish a software switch or direct connection between the user computer and the subject computer, the software switch connection between the user computer and the subject computer being constructed so when commands are executed on the user computer that are intended for the subject computer the software switch server will direct those commands to the subject computer, the software switch connection between the user computer and the subject computer being constructed so commands are executed on the user computer to copy selected data stored in a non-transitory computer-readable media of the subject computer to the non-volatile memory on the user computer in a manner that catalogues and preserves the integrity of the data, wherein the communication protocol operates in accordance with a communication protocol standard that permits transmission of one or more write commands for writing data to a non-transitory computer-readable media, and the subject computer is optionally configured to not write data to the non-transitory computer-readable media of the subject computer.

32. The computer system according to claim 31, wherein the software switch server is a software switch Virtual Machine running on a Virtual Machine server computer.

33. The computer system according to claim 31, wherein the subject computer is configured to not write data to the non-transitory computer-readable media of the subject computer.

34. The computer system according to claim 31, wherein the subject program code is constructed to translate commands from the non-transitory computer-readable media to a SCSI non-transitory computer-readable media device to be read only and cannot write to non-transitory computer-readable media in response to receiving any command including a write command

35. A method of performing examination and remediation services upon a subject computer having a non-transitory computer-readable media with a control computer, comprising:
executing subject program code on the subject computer, wherein the subject program code is constructed to translate commands from the non-transitory computer-readable media to a SCSI non-transitory computer-readable media device to be read only and optionally cannot write to non-transitory computer-readable media in response to receiving any command including a write command;
executing subject program code on the subject computer wherein the subject computer establishes a secure authenticated connection with the user computer;
executing user program code on the user computer wherein the user computer establishes a secure authenticated connection with the subject computer;
executing user program code on the user computer wherein the user program code is constructed to send commands to control the operation of the subject computer;
executing user program code on the user computer wherein the user computer is constructed to establish or disestablish connections between available subject computers; and
establishing a secure authenticated bidirectional connection between the subject computer and the user computer, wherein execution of the subject program code provides raw physical or logical access to the subject computer non-transitory computer-readable media from the user computer.

36. The method according to claim 35, wherein the subject program code is constructed to translate commands from the non-transitory computer-readable media to the SCSI non-transitory computer-readable media device to be read only and cannot write to non-transitory computer-readable media in response to receiving any command including a write command.

37. The method according to claim 35, further comprising translating commands to or from the subject computer virtual, logical, or physical non-transitory computer-readable media device to a SCSI non-transitory computer-readable media device and rendering the device as a read-only non-transitory computer-readable media device on the user computer.

38. The method according to claim 35, further comprising translating commands to or from the subject computer virtual, logical, or physical non-transitory computer-readable media device to a SCSI non-transitory computer-readable media device and rendering the device as a raw physical or logical non-transitory computer-readable media device on the user computer.

39. The method according to claim 35, wherein execution of the subject program code provides read-only access to the subject non-transitory computer-readable media from the user computer.

40. The method according to claim 35, wherein execution of the subject program code provides raw physical or logical access to the subject non-transitory computer-readable media from the user computer.

41. The method according to claim 35, wherein execution of the subject program code translates communications to or from a standard non-transitory computer-readable media device to a SCSI device and renders the subject computer device as a read-only non-volatile memory device to the user computer.

42. The method according to claim 41, wherein the standard non-transitory computer-readable media device is an ATA device.

43. The method according to claim 35, wherein execution of the subject program code translates communications to or from a standard non-transitory computer-readable media device to a SCSI device and renders the subject computer device as a raw physical or logical non-volatile memory device to the user computer.

44. The method according to claim 43, wherein the standard non-transitory computer-readable media device is an ATA device.

45. The method according to claim 35, wherein execution of the subject program code translates communications to or from a virtual non-transitory computer-readable media device to a SCSI device and renders the subject computer device as a read-only non-volatile memory device to the user computer.

46. The method according to claim 45, wherein the virtual non-transitory computer-readable media device is a RAID, iSCSI, Network Block Device, Logical Volume Manager, or TrueCrypt device.

47. The method according to claim 37, wherein execution of the subject program code translates communications to or from a virtual non-transitory computer-readable media device to a SCSI device and renders the subject computer device as a raw physical or logical non-volatile memory device to the user computer.

48. The method according to claim 41, wherein the virtual non-transitory computer-readable media device is a RAID, iSCSI, Network Block Device, Logical Volume Manager, or TrueCrypt device.

49. A computer program product, comprising one or more computer usable media having a computer readable program code embodied therein, the computer readable program code adapted to be executed by a first computer and a user computer to implement a method of performing a forensic investigation of the first computer, having a non-transitory computer-readable media, with the user computer, the computer program product comprising: a subject code segment for execution by the first computer; a user code segment for execution by the user computer; wherein the subject code segment and the user code segment are executable to establish a connection with a software switch server; wherein the software switch server is directed to patch the connections between the first computer and the subject computer such that data and commands can be transmitted between the subject computer and user computer via the switch computer over the patch between the established connections; wherein the communication protocol permits transmission of one or more write commands for writing data to a non-volatile, non-transitory, memory, wherein the subject code segment is executable to respond to a plurality of commands in accordance with the communication protocol; wherein the subject program code is constructed to translate commands from a non-transitory computer-readable media device to a SCSI non-transitory computer-readable media device to be read only and cannot write to non-transitory computer-readable media in response to receiving any command including a write command; and wherein the user code segment is executable to grant full access to the media of the subject computer via the software switch connection.

50. A computer program product, comprising one or more computer usable media having a computer readable program code embodied therein, the computer readable program code adapted to be executed by a first computer and a user computer to implement a method of performing a forensic investigation of the first computer, having a non-transitory computer-readable media, with the user computer, the computer program product comprising: a subject code segment for execution by the first computer; a user code segment for execution by the user computer; wherein the subject code segment and the user code segment are executable to establish direct bidirectional connections between the first computer and the subject computer such that data and commands can be transmitted between the subject computer and user computer between the established connections; wherein the communication protocol permits transmission of one or more write commands for writing data to a non-volatile, non-transitory, memory, wherein the subject code segment is executable to respond to a plurality of commands in accordance with the communication protocol; wherein the subject program code is constructed to translate commands from a non-transitory computer-readable media device to a SCSI non-transitory computer-readable media device to be read only and cannot write to non-transitory computer-readable media in response to receiving any command including a write command; and wherein the user code segment is executable to grant full access to the media of the subject computer via the direct connection.
